(19) United States
(12) Patent Application Publication
(10) Pub. No.: US 2012/0149438 A1
(43) Pub. Date: Jun. 14, 2012

(54) MOBILE PHONE OF FOLDING TYPE AND HINGE DEVICE OF THE SAME

(75) Inventor: Soon-Wook Kwon, Incheon (KR)

(73) Assignee: Prexco Co., Ltd., Chungcheongnam-do (KR)

(21) Appl. No.: 13/013,045

(22) Filed: Jan. 25, 2011

(30) Foreign Application Priority Data
Dec. 10, 2010 (KR) 10-2010-0126145

(51) Int. Cl. H04W 88/02; E05D 7/04

(52) U.S. Cl. 455/566; 16/248; 16/243

(57) ABSTRACT

A mobile phone of a folding type is disclosed. The mobile phone of a folding type according to an exemplary embodiment of the present invention may include: a first body provided with a first display portion; and a second body rotatably connected to the first body through at least one of a first hinge module and provided with a second display portion, wherein the first and second display portions form the same plane and are configured such that at least one of the first and second display portions can slide toward the other of the first and second display portions in a case that the first and second bodies are open.

### CROSS-REFERENCE TO RELATED APPLICATION

This application claims priority to and the benefit of Korean Patent Application No. 10-2010-0126145 filed in the Korean Intellectual Property Office on Dec. 10, 2010, the entire contents of which are incorporated herein by reference.

### BACKGROUND OF THE INVENTION

(a) Field of the Invention

The present invention relates to a mobile phone of a folding type. More particularly, the present invention relates to a mobile phone of a folding type and a hinge device of the same in which a cover is opened or shut by being rotated with respect to a main body in an upward or downward direction.

(b) Description of the Related Art

In general, mobile devices, such as mobile phones, PDAs, laptops, and DMB phones, are widely used for wireless services such as broadcasting and communication in a mobile fashion.

The mobile device is becoming an important necessity for convenience in life with the development in the information industry, while mobile phones are being used by elementary school, middle school, and high school students to the aged.

A variety of methods are used to open/shut a cover of the mobile devices, and they can be largely divided into a folding type, a slide type, and a swing type.

In particular, the covers of the mobile devices are opened/shut by being rotated with respect to a main body upwardly or downwardly in the folding type.

Such mobile devices of the folding type have several advantages, such as convenient, robustness, and refined design. Therefore, the folding type has been the most widely used in recent years.

In the mobile device of the folding type, a keypad is mounted at the main body and a display is mounted at the cover. When the cover faces the main body (that is, an angle between the cover and the main body is 0°), the cover is shut. If the cover rotates with respect to the main body upwardly, the cover is open.

Opening/shutting operations of the mobile device of the folding type are achieved by means of hinge devices, and manufacturers have recently manufactured the hinge devices having various structures. The hinge devices may include cams and springs or gears

Meanwhile, in order to enjoy multimedia services such as video, DMB, and games with a big screen, designers are recently immersed in developing mobile phones in which the display portion of the cover and the display portion of the main body are joined together when the cover is open.

According to such mobile phones, hinge devices are provided at both sides of a connecting portion of the cover and the main body, and the hinge devices connect the cover with the main body. In addition, the hinge devices are disposed along a rotation center axis supporting rotations of the cover and the main body.

However, since the cover and the main body are rotatably connected to each other though the hinge devices and the connecting portion is formed to be round for smooth rotation of the cover and the main body, a gap occurs between the display portion of the cover and the display portion of the main body according to conventional arts.

Due to the gap between the display portion of the cover and the display portion of the main body, the display portions cannot be joined together to form a big screen. Therefore, the conventional arts cannot satisfy user's needs of enjoying multimedia services such as video, DMB, games, and Internet.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a mobile phone of a folding type and a hinge device of the same having advantages that a display portion of a main body and a display portion of a cover are joined together to form a single big screen.

In addition, the present invention has been made in an effort to provide a mobile phone of a folding type and a hinge device of the same having further advantages of enlarging an exposing area of the main body at which function elements are mounted when the display portion of the main body and the display portion of the cover are joined together.

A mobile phone of a folding type according to an exemplary embodiment of the present invention may include: a first body provided with a first display portion; and a second body rotatably connected to the first body through at least one of a first hinge module and provided with a second display portion, wherein the first and second display portions form the same plane and are configured such that at least one of the first and second display portions can slide toward the other of the first and second display portions in a case that the first and second bodies are open.

The first and second display portions may be joined together to form a single display screen.

At least one of the first and second display portions can be slidable through a second hinge module.

At least one of the first and second display portions can slide by a moving region which corresponds to a gap between the first and second display portions.

At least one of the first and second bodies may be provided with an extra function means at an exposure portion according to the moving region, and at least one of the first and second display portions may cover or uncover the extra function means by a sliding movement thereof.

The extra function means may include an auxiliary speaker or a keypad.

The first hinge module may be mounted at both sides of a connecting portion of the first and second bodies and may include a gear hinge connected to the first and second bodies.

The second hinge module may include a slide hinge pivotably coupled to the first display portion and the first body or the second display portion and the second body.

According to an exemplary embodiment, the first hinge modules may be provided at both sides of the connecting portion of the first and second bodies such that the first and second bodies are connected to each other with a distance therebetween.

According to another exemplary embodiment, the first hinge module may be provided at both sides of the connecting portion of the first and second bodies such that the first and second bodies are contactedly connected to each other, and contacting portions of the first and second bodies are formed to be round.

A hinge device of the mobile phone of a folding type according to another exemplary embodiment of the present invention may include: a first hinge module mounted at both sides of a connecting portion of the first and second bodies so as to connect the first and second bodies to each other, and forming a rotation center axis of the first and second bodies; and a second hinge module mounted at least one of the first and second bodies, and slidably moving at least one of the first and second display portions when the first and second bodies are open.

The second hinge module may apply elastic force to at least one of the first and second display portions such that at least one of the first and second display portions slides toward the other of the first and second display portions by a moving region which corresponds to a gap between the first and second display portions.

The first hinge module may include: a hinge case mounted at both sides of the connecting portion of the first and second bodies; first and second hinge shafts rotatably mounted at the hinge case, and respectively connected to the first and second bodies; a gear unit for rotating the first and second hinge shafts; a rotating cam mounted respectively at the first and second hinge shafts; a moving cam movably mounted at the first and second hinge shafts along a length direction thereof, and cam-contacted to the rotating cam; and a spring member mounted at the first and second hinge shafts, and applying elastic force to the moving cam.

The gear unit may include: first and second drive gears coupled respectively to the first and second hinge shafts; a first driven gear rotatably mounted at the hinge case, and engaged with the first drive gear; and a second driven gear rotatably mounted at the hinge case, and engaged with the first driven gear and the second drive gear.

The second hinge module may include: a fixed member fixedly mounted at least one of the first and second bodies; a sliding member fixedly mounted at a bottom surface of at least one of the first and second display portions, and slidably coupled to the fixed member; and an elastic link disposed between and pivotably coupled to the fixed member and the sliding member.

The elastic link may include: an elastic member of a spiral shape pivotably coupled to the fixed member; and an arm member connected to the elastic member and slidably coupled to the sliding member.

### BRIEF DESCRIPTION OF THE DRAWINGS

The drawings illustrate exemplary embodiments of the present invention and are not construed to limit any aspect of the invention.

FIG. 1A to FIG. 1C are perspective views of a mobile phone of a folding type according to an exemplary embodiment of the present invention.

FIG. 2 is a top plan view of a mobile phone illustrated in FIG. 1C.

FIG. 3 is an exploded perspective view of a hinge device of a mobile phone of a folding type according to an exemplary embodiment of the present invention.

FIG. 4 is an exploded perspective view of a first hinge module used in a hinge device of a mobile phone of a folding type according to an exemplary embodiment of the present invention.

FIG. 5 is a schematic diagram of a gear unit used in a first hinge module illustrated in FIG. 4.

FIG. 6 is an exploded perspective view of a second hinge module used in a hinge device of a mobile phone of a folding type according to an exemplary embodiment of the present invention.

FIG. 7A to FIG. 7C show operation of a hinge device of a mobile phone of a folding type according to an exemplary embodiment of the present invention.

FIG. 8 is a top plan view of a mobile phone of a folding type according to another exemplary embodiment of the present invention.

FIG. 9A to FIG. 9C illustrate a mobile phone of a folding type according to other exemplary embodiment of the present invention.

<Description of Symbols>

| | |
|---|---|
| 10: first body | 11: first display portion |
| 20: second body | 21: second display portion |
| 30: extra function means | 50: hinge arm |
| 110: first hinge module | 120: hinge case |
| 121: upper case | 122: lower case |
| 130: first hinge shaft | 135, 145: connecting bracket |
| 140: second hinge shaft | 150: gear unit |
| 151: first drive gear | 152: second drive gear |
| 153: first driven gear | 154: second driven gear |
| 160: rotating cam | 161: first cam protrusion |
| 170: moving cam | 171: first cam portion |
| 172: second cam portion | 173, 174: second cam protrusion |
| 180: spring member | 210: second hinge module |
| 220: fixed member | 221: body portion |
| 223: guide groove | 225: groove member |
| 230: sliding member | 231: rail portion |
| 250: elastic link | 261: elastic member |
| 271: arm member | A: rotation center axis |

### DETAILED DESCRIPTION OF THE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

Description of components that are not necessary for explaining the present invention will be omitted, and the same constituent elements are denoted by the same reference numerals in this specification.

In the detailed description, ordinal numbers are used for distinguishing constituent elements having the same terms, and have no specific meanings.

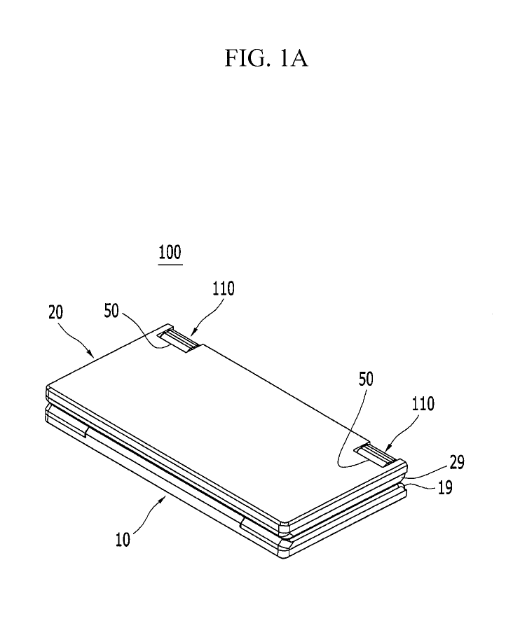

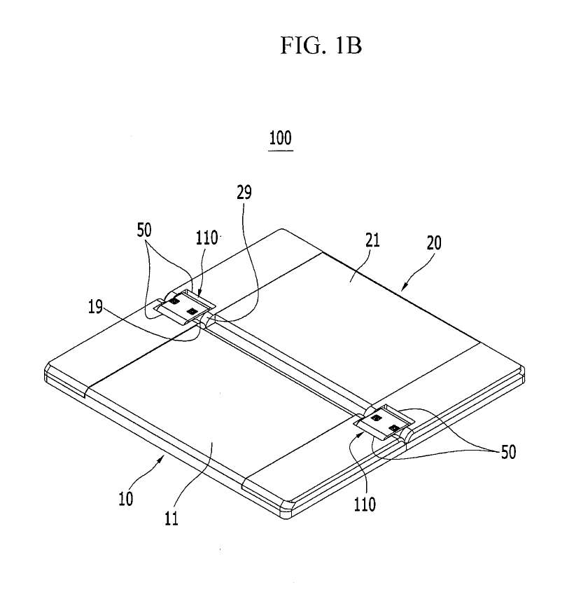

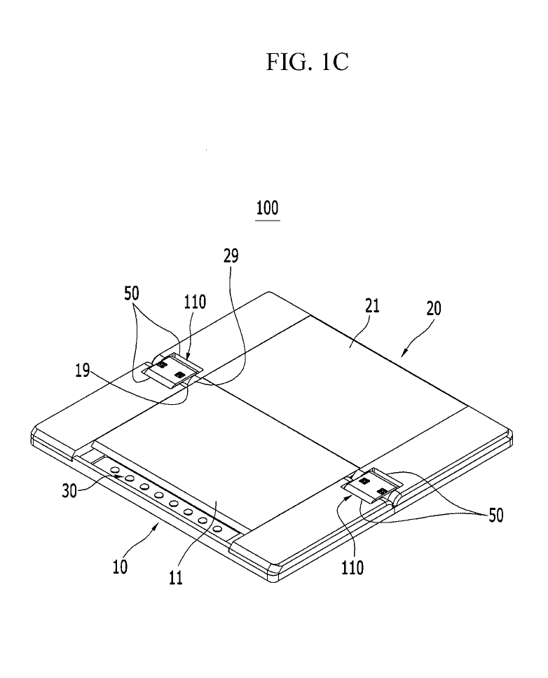

FIG. 1A to FIG. 1C are perspective views of a mobile phone of a folding type according to an exemplary embodiment of the present invention.

Referring to the drawings, a mobile phone 100 of a folding type according to an exemplary embodiment of the present invention performs basic functions such as voice/video communication and message delivery, and can be used for enjoying multimedia services such as data input, DMB, video, games, and Internet.

Such a mobile phone 100 includes a first body 10 which is a main body and a second body 20 which is a cover.

The mobile phone 100 is a mobile phone of a folding type in which the second body 20 is open/shut by being rotated with respect to the first body 10, upwardly or downwardly.

In this specification, a surface on which a display portion is positioned when the mobile phone 100 is open is defined as a front surface. In addition, a left and/or right direction is defined as a length direction, and an upward and/or downward direction is defined as a width direction in FIG. 1A to FIG. 1C.

However, such directions are arbitrarily defined and may change according to a position of the mobile phone 100 with respect to a user.

Herein, the mobile phone 100 may be a wide display phone, and the first body 10 and the second body 20 have a rectangular shape. That is, lengths of the first body 10 and the second body 20 are longer than widths thereof.

In a state that the first and second bodies 10 and 20 face each other (closed state) as shown in FIG. 1A, the second body 20 rotates in the width direction (i.e., upward or downward direction) with respect to the first body 10. Therefore, the first and second bodies 10 and 20 are opened as shown in FIG. 1B.

In addition, a first display portion 11 formed of a touch screen is provided at a front surface of the first body 10 and a second display portion 21 formed of a touch screen or a liquid crystal panel is provided at a front surface of the second body 20 in the mobile phone 100, as shown in FIG. 1B.

The first display portion 11 is extended to a lower end of the front surface of the first body 10, and the second display portion 21 is extended to an upper end of the front surface of the second body 20. The first and second display portions 11 and 21 display the multimedia such as DMB, video, games, and Internet.

In this case, the first display portion 11 can display a menu key, a direction key, and qwerty keys of the mobile phone 100, and enables the keys to operate. The qwerty keys enable the user to input the English alphabet and the Korean alphabet.

The mobile phone 100 according to an exemplary embodiment of the present invention is configured such that the second body 20 is rotated in the upward direction with respect to the first body 10 through a first hinge module 110 of a hinge device 200 so as to open the first and second bodies 10 and 20 to a reference opening angle (for example, 180 degrees) (referring to FIG. 1B).

Herein, when the first and second bodies 10 and 20 are open, the first and second display portions 11 and 21 are configured to form the same plane and are positioned in parallel along the length direction thereof.

In addition, when the first and second bodies 10 and 20 are open, a gap with a predetermined space is formed between the first and second display portions 11 and 21.

The first and second bodies 10 and 20 are rotatably connected to each other through the first hinge module 110, and round portions 19 and 29 are formed at connecting portions of the bodies 10 and 20 for the bodies 10 and 20 to rotate smoothly. Thereby, the gap is formed.

When the first and second bodies 10 and 20 rotate, the bodies 10 and 20 can contact each other. The round portions 19 and 29 formed at the connecting portions of the first and second bodies 10 and 20 prevent rotational interference between the bodies 10 and 20.

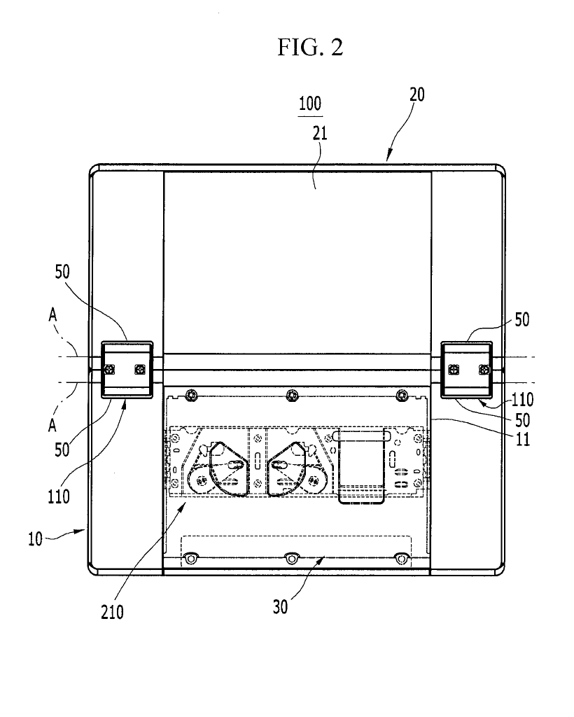

In a state that the first and second bodies 10 and 20 are open to form 180 degrees therebetween as shown in FIG. 1C and FIG. 2, the mobile phone 100 according to the present exemplary embodiment is configured such that one of the first and second display portions 11 and 21 can slide toward the other of the first and second display portions 11 and 21 through a second hinge module 210 of the hinge device 200.

According to the present exemplary embodiment, the first display portion 11 may slide toward the second display portion 21 on the first body 10 and the second display portion 21 may be fixed to the second body 20. That is, the first display portion 11 slides upwardly with respect to the first body 10 by a moving region corresponding to the gap between the first and second display portions 11 and 21 according to the present exemplary embodiment. Thereby, the first and second display portions 11 and 21 contact each other to form a single display screen.

In this case, the first display portion 11 of the first body 10 and the second display portion 21 of the second body 20 are joined together through an interface control of a display driving module according to prior arts. Therefore, the user can enjoy multimedia conveniently through a big screen.

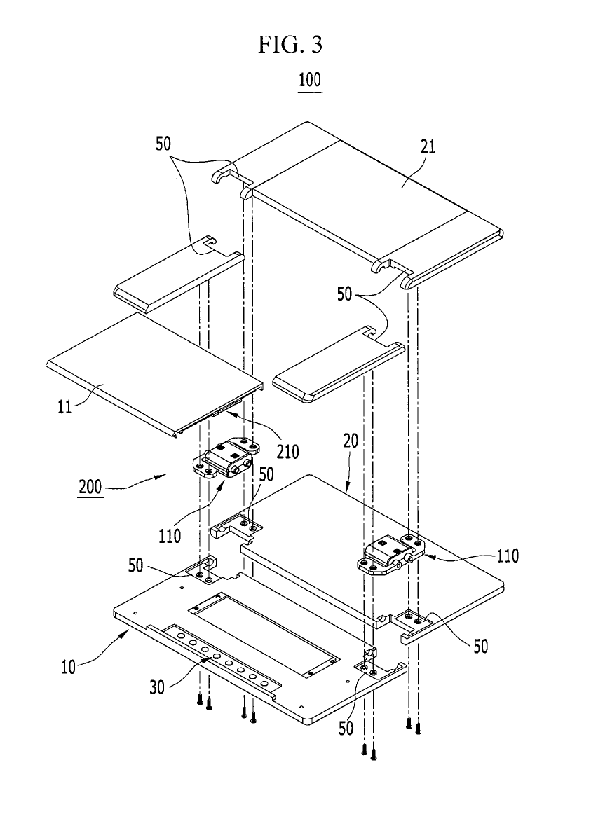

The first and second hinge modules 110 and 210 of the hinge device 200 according to an exemplary embodiment of the present invention will be described in detail referring to FIG. 3 to FIG. 6.

As described above, in a state that the first and second bodies 10 and 20 are open to form 180 degrees therebetween, the first display portion 11 of the first body 10 slides upwardly so as to join together with the second display portion 21 of the second body 20 to form a single screen according to the present exemplary embodiment. At this time, a part of a lower end of the first body 10 may be exposed (referring to FIG. 2).

Herein, extra function means 30 (for example, a high performance auxiliary speaker or a keypad including menu keys) which perform various extra functions of the mobile phone 100 may be provided at the part of the lower end of the first body 10 (i.e., an exposure portion), as shown in FIG. 2.

Therefore, in a state that the first and second bodies 10 and 20 are shut as shown in FIG. 1A, the mobile phone 100 according to an exemplary embodiment of the present invention is configured such that the second body 20 can be rotated upwardly with respect to the first body 10 through the first hinge module 110 for the angles between the first and second bodies 10 and 20 to become 180 degrees as shown in FIG. 1B. Accordingly, the first and second bodies 10 and 20 may be open.

When the first and second bodies 10 and 20 are open, the first and second display portions 11 and 21 form the same plane, and thereby the user can enjoy multimedia such as DMB, video, games, and Internet, and input the English alphabet or the Korean alphabet through the first and second display portions 11 and 21.

In this state, the first display portion 11 can be slid upwardly with respect to the first body 10 by the moving region corresponding to the gap between the first and second display portions 11 and 21, as shown in FIG. 1C and FIG. 2.

Therefore, the first and second display portions 11 and 21 are joined together to form the single display screen and the user can enjoy multimedia through the big screen according to the present exemplary embodiment.

In addition, if the first display portion 11 slides upwardly, the extra function means 30 provided at the lower end of the first body 10 can be exposed according to the present exemplary embodiment. Therefore, the user can use various extra functions of the mobile phone 100 through the extra function means 30 efficiently.

Until now, it has been exemplified that the spirit of the present invention is applied to the mobile phone 100, but it is not limited thereto. That is, the spirit of the present invention can be applied to portable electric/electronic devices such as a PDA, a PMP, a smart phone, a hand-held PC, MP3/MP4 players, a game console, a netbook, and a laptop.

Such portable electric/electronic devices may have predetermined communication modules such as code division multiplexing access (CDMA) modules, Bluetooth modules, infrared data association (IrDA) modules, and wire/wireless LAN cards. Also, the portable electric/electronic devices may have predetermined microprocessors by which multimedia can be played.

Hereinafter, the hinge device 200 used in the mobile phone of a folding type according to an exemplary embodiment of the present invention will be described in detail with reference to the accompanying drawings.

FIG. 3 illustrates a slide state of the first display portion 11 in a state that the first and second bodies 10 and 20 of the mobile phone 100 are open to form 180 degrees therebetween.

Referring to the drawing, the hinge device 200 of the mobile phone of a folding type according to an exemplary embodiment of the present invention may open or close the first and second bodies 10 and 20 within a range of 0-180 degrees. In addition, the hinge device 200 is configured to slide the first display portion 11 of the first body 10 toward the second display portion 21 of the second body 20 in a state that the first and second bodies 10 and 20 are open.

For this purpose, the hinge device 200 according to the present exemplary embodiment includes the first hinge module 110 and the second hinge module 210, and the first and second hinge modules 110 and 210 will now be described in detail.

According to the present exemplary embodiment, the first hinge module 110 enables the first and second bodies 10 and 20 to rotate relatively.

For example, if the user exerts torque on the second body 20 so as to rotate the second body 20 which is the cover with respect to the first body 10 which is the main body by a predetermined portion of an entire rotation region, the first hinge module 110 helps the second body 20 rotate for the other portion of the entire rotation region automatically by elastic restoring force of a spring.

The first hinge module 110 is connected to both of the connecting portions of the first and second bodies 10 and 20 at both sides of the bodies 10 and 20.

For this purpose, hinge arms 50 (referring to FIG. 1A to FIG. 1C) facing each other are formed at both sides of the connecting portions of the first and second bodies 10 and 20. The hinge arms are concave and are used for mounting the first hinge module 110.

The first hinge module 110 connects the first and second bodies 10 and 20 to each other and forms a rotation center axis A of the first and second bodies 10 and 20 as shown in FIG. 2.

The rotation center axis A connects the first and second bodies 10 and 20 to each other and supports the bodies 10 and 20 to rotate relatively. The first and second bodies 10 and 20 rotate about the rotation center axis A upwardly or downwardly so as to be open or shut.

The first hinge modules 110 according to the present exemplary embodiment are mounted on the hinge arms 50 at both sides of the connecting portions of the first and second bodies 10 and 20, and may be formed as gear hinges connected to the first and second bodies 10 and 20.

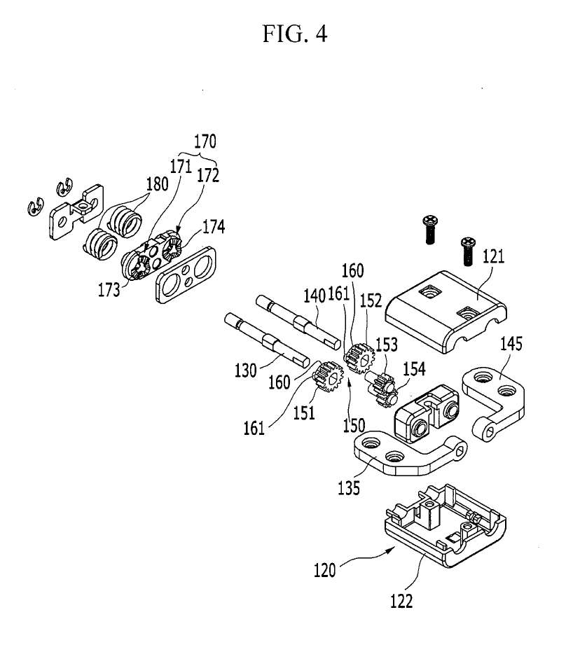

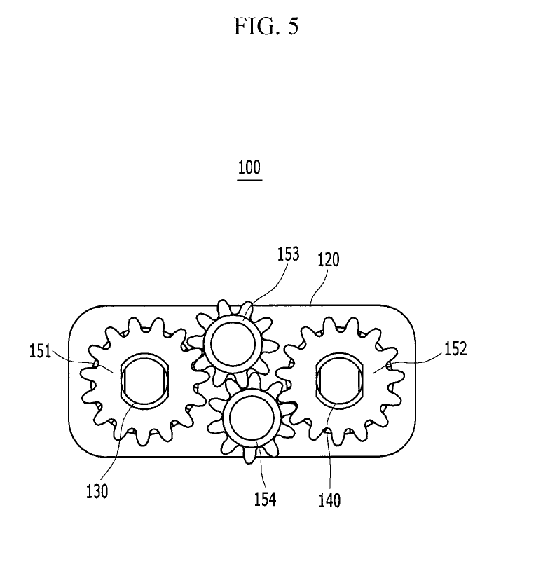

FIG. 4 is an exploded perspective view of a first hinge module used in a hinge device of a mobile phone of a folding type according to an exemplary embodiment of the present invention, and FIG. 5 is a schematic diagram of a gear unit used in a first hinge module illustrated in FIG. 4.

Referring to the drawings, the first hinge module 110 according to the present exemplary embodiment includes a hinge case 120, first and second hinge shafts 130 and 140, a gear unit 150, a rotating cam 160, a moving cam 170, and a spring member 180.

According to the present exemplary embodiment, constituent elements forming the first hinge module 110 are mounted at the hinge case 120, and the hinge cases 120 are disposed on the hinge arm 50 at both sides of the connecting portions of the first and second bodies 10 and 20.

Accessorial components such as blocks, protrusions, ribs, grooves, and holes are provided at the hinge case 120.

Such accessorial components are used for supporting constituent elements, and will be commonly designated as the hinge case 120 unless otherwise defined herein.

The hinge case 120 includes an upper case 121 and a lower case 122, and the upper and lower cases 121 and 122 are engaged by a bolt.

Considering ease of manufacturing the hinge case 120, inner structures of the upper case 121 and the lower case 122 may be the same. Considering installability of the constituent elements, however, the inner structures of the upper case 121 and the lower case 122 may be different.

According to the present exemplary embodiment, the first and second hinge shafts 130 and 140 are used for forming the rotation center axis A (referring to FIG. 2) of the first and second bodies 10 and 20. The first and second hinge shafts 130 and 140 are disposed in the hinge case 120 in parallel with each other, and are rotatably mounted to the hinge case 120.

In this case, both ends of the first and second hinge shafts 130 and 140 are protruded from the hinge case 120 and are connected to the first and second bodies 10 and 20 in the hinge arm 50 thereof.

For example, the first and second hinge shafts 130 and 140 are connected to the first and second bodies 10 and 20 through connecting brackets 135 and 145. The connecting brackets 135 and 145 are connected to the first and second hinge shafts 130 and 140 and are engaged to the first and second bodies 10 and 20 by bolts.

According to the present exemplary embodiment, the gear unit 150 drives the first and second hinge shafts 130 and 140, and includes first and second drive gears 151 and 152 and first and second driven gears 153 and 154.

The first and second drive gears 151 and 152 are engaged respectively to the first and second hinge shafts 130 and 140. The drive gears 151 and 152 may be insertedly engaged to the first and second hinge shafts 130 and 140 or may be integrally formed with the first and second hinge shafts 130 and 140 through molding.

In addition, the first and second driven gears 153 and 154 are rotatably mounted to the hinge case 120 between the first and second drive gears 151 and 152.

Herein, the first driven gear 153 is rotatably mounted to the hinge case 120, and is engaged to the first drive gear 151. The first driven gear 153 rotates in an opposite direction of a rotating direction of the first hinge shaft 130.

In addition, the second driven gear 154 is rotatably mounted to the hinge case 120 corresponding to the first driven gear 153, and is engaged with the first driven gear 153 and the second drive gear 152.

In this case, the second driven gear 154 rotates in an opposite direction of a rotating direction of the first driven gear 153, and transmits torque to the second hinge shaft 140 through the second drive gear 152.

For example, if the first drive gear 151 rotates in one direction by the rotation of the first hinge shaft 130 according to the rotation of the second body 20, the first driven gear 153 rotates in the other direction and the second driven gear 154 rotates in the one direction.

Since the second drive gear 152 is engaged with the second driven gear 154, the second hinge shaft 140 rotates in the other direction which is opposite to the rotating direction of the first hinge shaft 130.

According to the present exemplary embodiment, the rotating cams 160 are provided respectively at the first and second hinge shafts 130 and 140. The rotating cams 160 may be integrally formed with the first and second drive gears 151 and 152 or may be inserted mounted in the first and second hinge shafts 130 and 140.

The rotating cam 160 is formed of a first cam protrusion 161 including a protrusion portion and a depression portion.

In addition, the moving cam 170 is movably mounted at the first and second hinge shafts 130 and 140 along the length direction thereof in the hinge case 120. The moving cam 170 is cam-contacted with the rotating cam 160.

The moving cam 170 has a single plate shape, and both of the first and second hinge shafts 130 and 140 are inserted in the moving cam 170. The moving cam 170 is formed of first and second cam portions 171 and 172 corresponding to the rotating cams 160 of the hinge shafts 130 and 140.

Herein, the first and second cam portions 171 and 172 of the moving cam 170 are formed of a protrusion portion and a depression portion, and are provided with second cam protrusions 173 and 174 cam-contacted with the first cam protrusions 161 of the rotating cam 160.

According to the present exemplary embodiment, the spring member 180 exerts elastic force on the moving cam 170, and may be a coil spring which is mounted at each of the hinge shafts 130 and 140.

That is, one end portion of the spring member 180 is supported by the hinge case 120 and the other end portion of the spring member 180 is supported by the moving cam 170.

According to the present exemplary embodiment, the second hinge module 210 is configured such that at least one of the first display portion 11 of the first body 10 and the second display portion 21 of the second body 20, suitably the first display portion 11, is slid toward the second display portion 21 in a state that the first and second bodies 10 and 20 are open.

The second hinge module 210 may be called “slide hinge module” or “elastic link module”.

The second hinge module 210 slides the first display portion 11 upwardly or downwardly with respect to the first body 10, and is configured to selectively expose the extra function means 30 of the first body 10.

In a case that the first display portion 11 slides toward the second display portion 21, if the user exerts force on the first display portion 11 so as to slide the first display portion 11 by a predetermined portion of an entire moving region, the second hinge module 210 helps the first display portion 11 slide for the other portion of the entire moving region automatically by elastic restoring force of a spring.

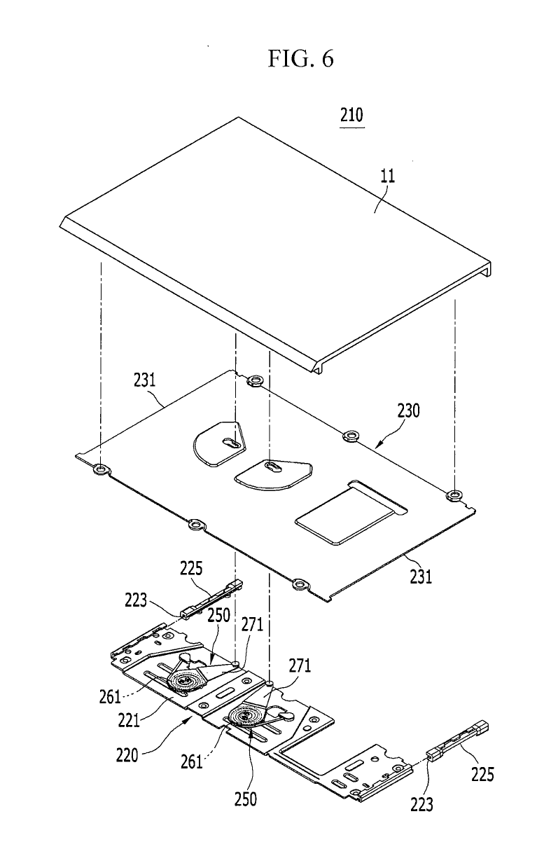

FIG. 6 is an exploded perspective view of a second hinge module used in a hinge device of a mobile phone of a folding type according to an exemplary embodiment of the present invention.

Referring to the drawing, the second hinge module 210 according to the present exemplary embodiment may be formed as a slide hinge pivotably coupled to the first display portion 11 and the first body 10. The second hinge module 210 includes a fixed member 220, a sliding member 230, and an elastic link 250.

The fixed member 220 and the sliding member 230 correspond to each other, and are configured to be mounted respectively to the first body 10 and the first display portion 11 and to be slidably engaged to each other. Therefore, if the siding member 230 slides to one direction, the fixed member 220 slides to the other direction or does not slide.

According to the present exemplary embodiment, the fixed member 220 means a member which does not slide and the sliding member 230 means a member which slides.

That is, the fixed member 220 may be a fixed plate and the sliding member 230 may be a moving plate.

According to the present exemplary embodiment, the fixed member 220 is the fixed plate and is made of a metallic material or synthetic resin material. The fixed member 220 is fixedly mounted at the first body 10 corresponding to a lower surface of the first display portion 11 through engaging means such as a bolt or a rivet.

The fixed member 220 includes a body portion 221 having a plate shape and made of a metal material, and a groove member 225 made of a synthetic resin, fixed to both side portions of the body portion 221, and provided with a guide groove 223.

According to the present exemplary embodiment, the sliding member 230 is the moving plate and is made of a metal material or synthetic resin material. The sliding member 230 is fixedly mounted at the lower surface of the first display portion 11 through engaging means such as a bolt or a rivet.

The sliding member 230 is slidably coupled to the fixed member 220, and a width of the sliding member 230 may be greater than that of the fixed member 220. The sliding member 230 is provided with rail portions 231 at both sides thereof, and the rail portion 231 is slidably coupled to the guide groove 223 of the fixed member 220.

According to the present exemplary embodiment, the elastic link 250 exerts elastic force on the fixed member 220 and the sliding member 230 for the other portion of the entire moving region so as to slide the first display portion 11 automatically in a case that the first display portion 11 slides by the predetermined portion of the entire moving region.

A pair of the elastic links 250 is provided between the fixed member 220 and the sliding member 230. One end of the elastic link 250 is pivotably coupled to the fixed member 220 and the other end of the elastic link 250 is slidably coupled to the sliding member 230.

One example of the elastic link 250 includes an elastic member 261 of a spiral shape pivotably coupled to the fixed member 220 and an arm member 271 slidably coupled to the sliding member 230.

The elastic member 261 may be manufactured by winding a wire spring in a spiral shape, and may be pivotably coupled to the fixed member 220 through a hinge pin (not shown).

In addition, the arm member 271 has a plate shape and supports the elastic member 261. The arm member 271 is slidably coupled to the sliding member 230 through a hinge pin (not shown).

Hereinafter, operation/movement of the mobile phone 100 of a folding type and the hinge device 200 provided at the same according to the exemplary embodiment of the present invention will be described in detail with reference to the accompanying drawings.

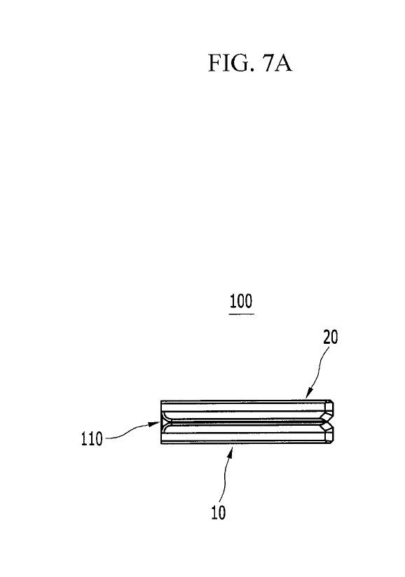

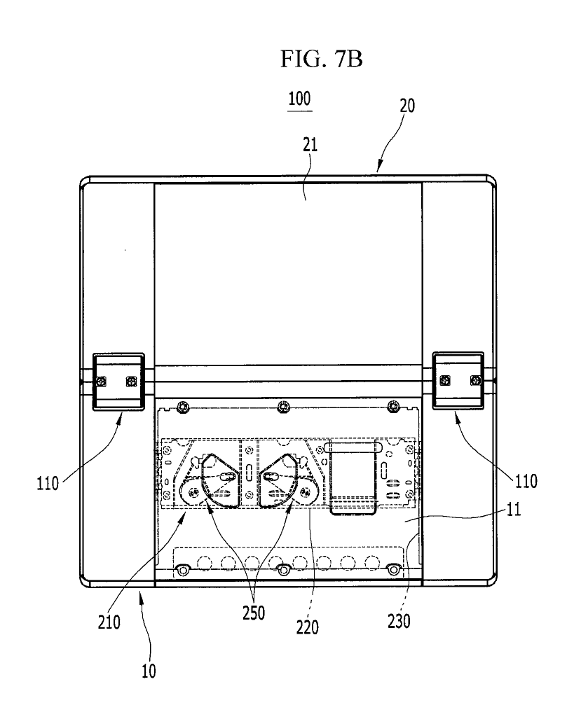

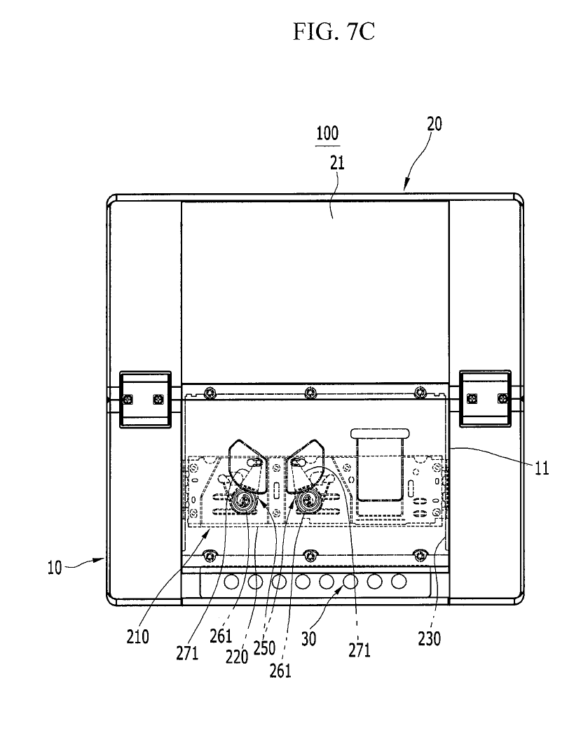

FIG. 7A to FIG. 7C show operation of a hinge device of a mobile phone of a folding type according to an exemplary embodiment of the present invention.

As shown in FIG. 7A, a state in which the first body 10 and the second body 20 of the mobile phone 100 face each other is defined as an initial point.

In this case, the first and second bodies 10 and 20 are closely contacted with each other by elastic force applied from the first hinge module 110.

In this state, the second body 20 is rotated upwardly with respect to the first body 10 by the predetermined portion of the entire rotation region.

Then, the first and second bodies 10 and 20 are rotated in an opposite direction to each other by the torque applied to the first and second hinge shafts 130 and 140 through the gear unit 150 of the first hinge module 110.

In this case, since the first and second hinge shafts 130 and 140 are rotated, the spring member 180 is compressed by cam-operation of the rotating cam 160 and the moving cam 170 of the first hinge module 110. In addition, compression elastic force of the spring member 180 is applied to the first and second hinge shafts 130 and 140.

After that, if the user exerts a little torque to the second body 20, the compression elastic force of the spring member 180 is transmitted to the first and second bodies 10 and 20 through the first and second hinge shafts 130 and 140. Therefore, the first and second bodies 10 and 20 are rotated automatically for the other portion of the entire rotation region and are open as shown in FIG. 7B.

In this case, the elastic link 250 of the second hinge module 210 is connected to the fixed member 220 and the sliding member 230, and exerts no or a little compression elastic force to the fixed member 220 and the sliding member 230.

When the first and second bodies 10 and 20 are open to form 180 degrees therebetween, the first and second display portions 11 and 21 form the same plane according to the present exemplary embodiment. Therefore, the user can enjoy multimedia such as DMB, video, games, and Internet, and input the English alphabet or Korean alphabet through the first and second display portions 11 and 21.

Meanwhile, close processes of the first and second bodies 10 and 20 can proceed in a reverse order of opening processes of the first and second bodies 10 and 20 according to the present exemplary embodiment. Therefore, a detailed description thereof will be omitted.

In the state as described above, the first display portion 11 of the first body 10 can be slid upwardly by the second hinge module 210 as shown in FIG. 7C.

These processes will be described in detail.

In the state shown in FIG. 7B, the first display portion 11 is slid upwardly by the predetermined portion of the entire moving region corresponding to the gap between the first and second display portions 11 and 21.

Then, the sliding member 230 of the second hinge module 210 is slid upwardly with respect to the fixed member 220 by the predetermined portion of the entire moving region. Therefore, the arm member 271 of the elastic link 250 rotates and the elastic member 261 is compressed. Thereby, the elastic force is applied to the fixed member 220 and the sliding member 230.

If the user applies more force upwardly to the first display portion 11 in this state, the first display portion 11 is slid automatically by the elastic force of the elastic member 261 applied to the fixed member 220 and the sliding member 230.

Therefore, the first display portion 11 is slid upwardly through the second hinge module 210, and the first and second display portions 11 and 21 are joined together to form the single display screen by the interface control of the display driving module.

Since the first and second display portions 11 and 21 are joined together to form the single display screen according to the present exemplary embodiment, the user can enjoy multimedia conveniently with the big screen.

In addition, since the extra function means 30 disposed at the lower end portion of the first body 10 is exposed to the exterior by sliding the first display portion 11 upwardly according to the present exemplary embodiment, an exposing area of the body at which extra function elements are installed can be further enlarged. Therefore, the user can use extra functions of the mobile phone 100 conveniently through the extra function means 30 and diversified demands of the user can be satisfied sufficiently.

Meanwhile, closing processes of the extra function means 30 of the first body 10 can proceed in reverse order of opening processes of the extra function means according to the present exemplary embodiment. Therefore, a detailed description thereof will be omitted.

In this specification, it is exemplified that the first display portion 11 is slid upwardly with respect to the first body 10 through the second hinge module 210 in a state that the first and second bodies 10 and 20 are open through the first hinge module 110.

However, the present invention is not limited thereto. That is, the second display portion 21 may be slid downwardly through the second hinge module 210.

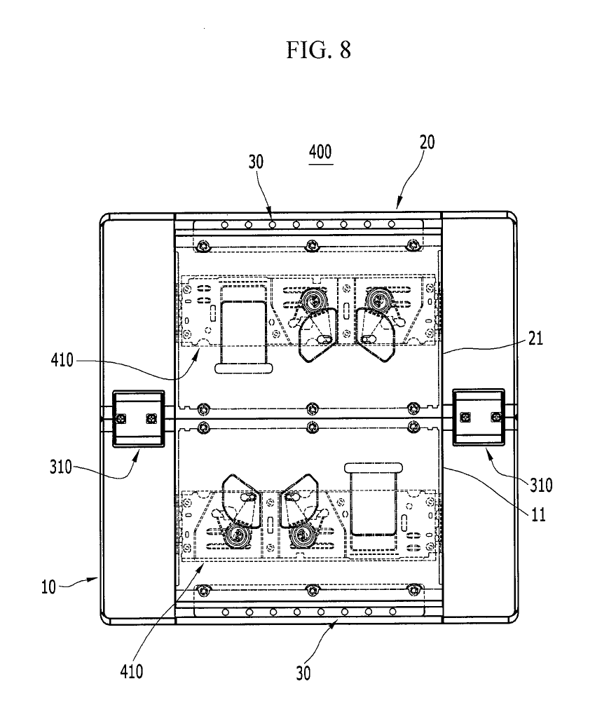

FIG. 8 is a top plan view of a mobile phone of a folding type according to another exemplary embodiment of the present invention.

Referring to the drawing, a mobile phone 400 of a folding type according to another exemplary embodiment of the present invention is similar to that according to an exemplary embodiment of the present invention. The difference therebetween is that both of the first and second display portions 11 and 21 can slide in a state that the first and second bodies 10 and 20 are open according to another exemplary embodiment.

According to another exemplary embodiment, in a state that the first and second bodies 10 and 20 are open by a first hinge module 310, the first display portion 11 can slide upwardly with respect to the first body 10 by a second hinge module 410 for a predetermined region.

In addition, the second display portion 21 can slide downwardly with respect to the second body 20 by the second hinge module 410 for a predetermined region.

The second hinge module 410 used for sliding the second display portion 21 is pivotably connected to the second display portion 21 and the second body 20.

Since the second hinge module 410 is the same as the second hinge module according to an exemplary embodiment, a detailed description thereof will be omitted.

Herein, the first and second display portions 11 and 21 can slide upwardly or downwardly by the moving region corresponding to the gap therebetween, and can be joined together to form a single big screen.

Meanwhile, if the first and second display portions 11 and 21 slide upwardly or downwardly to be joined together in a state that the first and second bodies 10 and 20 are open, a portion of the lower end of the first body 10 and a portion of an upper end of the second body 20 may be exposed.

Herein, the extra function means 30 (for example, a high performance auxiliary speaker or a keypad including menu keys) which perform various extra functions of the mobile phone 400 may be provided at exposure portions of the first and second bodies 10 and 20.

Since other components of the mobile phone 400 according to another exemplary embodiment of the present invention are the same as those according to an exemplary embodiment of the present invention, detailed description thereof will be omitted in this specification.

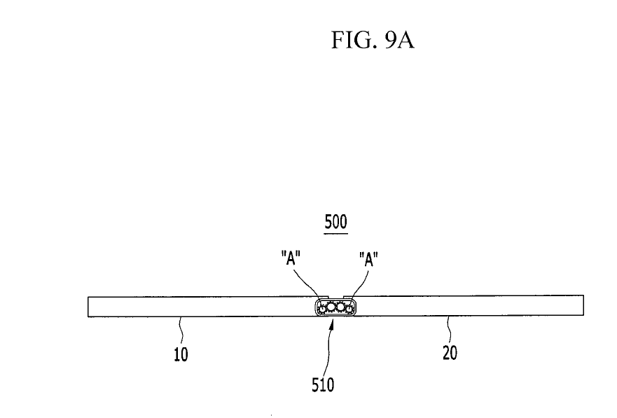

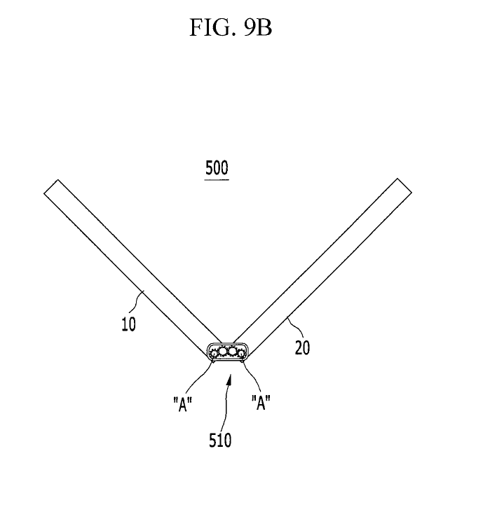

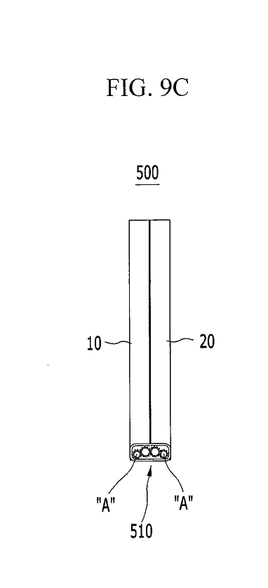

FIG. 9A to FIG. 9C illustrate a mobile phone of a folding type according to other exemplary embodiment of the present invention.

Referring to the drawings, a mobile phone 500 of a folding type according to other exemplary embodiment of the present invention is similar to that according to an exemplary embodiment of the present invention. The difference therebetween is that first hinge modules 510 are provided at both sides of the connecting portions of the bodies 10 and 20 such that the first and second bodies 10 and 20 are connected to each other with a distance therebetween.

According to other exemplary embodiment, the first hinge module 510 may be formed as a gear hinge such as that of an exemplary embodiment. In addition, rotation center axes A of the first and second bodies 10 and 20 are positioned on the connecting portions of the first and second bodies 10 and 20.

In this case, the connecting portions of the first and second bodies 10 and 20 may not be rounded but may be angulated.

Even if the connecting portions of the first and second bodies 10 and 20 are angulated according to other exemplary embodiment, the first and second bodies 10 and 20 are connected to each other with the distance therebetween by the first hinge module 510. Therefore, rotation interference between the first and second bodies 10 and 20 does not occur.

Since other components of the mobile phone of a folding type according to another exemplary embodiment of the present invention are the same as those according to an exemplary embodiment of the present invention, a detailed description thereof will be omitted.

In a state that the first and second bodies are open to form 180 degrees therebetween by the first hinge module, at least one of the first and second display portions slides by the second hinge module such that the display portions are joined together to form a single big screen according to the present invention. Therefore, a user can enjoy multimedia conveniently through the big screen.

In addition, at least one of the first and second display portions slides so as to expose a part of the first body or the second body, and extra function means are provided at an exposure portion according to the present invention.

Therefore, the exposure portion at which function elements are mounted may be enlarged. In addition, a user can use extra functions of the mobile phone conveniently through the extra function means, and diversified demands of the user can be satisfied sufficiently.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A mobile phone of a folding type comprising:
a first body provided with a first display portion; and
a second body rotatably connected to the first body through at least one of a first hinge module and provided with a second display portion,
wherein the first and second display portions form the same plane and are configured such that at least one of the first and second display portions can slide toward the other of the first and second display portions in a case that the first and second bodies are open.

2. The mobile phone of claim 1, wherein the first and second display portions are joined together to form a single display screen.

3. The mobile phone of claim 1, wherein at least one of the first and second display portions can be slidable through a second hinge module.

4. The mobile phone of claim 3, wherein at least one of the first and second display portions can slide by a moving region which corresponds to a gap between the first and second display portions.

5. The mobile phone of claim 4, wherein at least one of the first and second bodies is provided with an extra function means at an exposure portion according to the moving region, and at least one of the first and second display portions covers or uncovers the extra function means by a sliding movement thereof.

6. The mobile phone of claim 5, wherein the extra function means comprises an auxiliary speaker or a keypad.

7. The mobile phone of claim 1, wherein the first hinge module is mounted at both sides of a connecting portion of the first and second bodies, and includes a gear hinge connected to the first and second bodies.

8. The mobile phone of claim 3, wherein the second hinge module includes a slide hinge pivotably coupled to the first display portion and the first body or the second display portion and the second body.

9. The mobile phone of claim 8, wherein the first hinge modules are provided at both sides of the connecting portion of the first and second bodies such that the first and second bodies are connected to each other with a distance therebetween.

10. The mobile phone of claim 8, wherein the first hinge modules are provided at both sides of the connecting portion of the first and second bodies such that the first and second bodies are contactedly connected to each other, and contacting portions of the first and second bodies are formed to be round.

11. A hinge device of a mobile phone of a folding type which is provided at the mobile phone of a folding type provided with a first body having a first display portion and a second body having a second display portion, wherein the first and second display portions form the same plane in a case that the first and second bodies are open, the hinge device comprising:
a first hinge module mounted at both sides of a connecting portion of the first and second bodies so as to connect the first and second bodies to each other, and forming a rotation center axis of the first and second bodies; and
a second hinge module mounted at least one of the first and second bodies, and slidably moving at least one of the first and second display portions when the first and second bodies are open.

12. The hinge device of claim 11, wherein the second hinge module applies elastic force to at least one of the first and second display portions such that at least one of the first and second display portions slides toward the other of the first and second display portions by a moving region which corresponds to a gap between the first and second display portions.

13. The hinge device of claim 11, wherein the first hinge module comprises:
a hinge case mounted at both sides of the connecting portion of the first and second bodies;
first and second hinge shafts rotatably mounted at the hinge case, and respectively connected to the first and second bodies;
a gear unit for rotating the first and second hinge shafts;
a rotating cam mounted respectively at the first and second hinge shafts;
a moving cam movably mounted at the first and second hinge shafts along a length direction thereof, and cam-contacted to the rotating cam; and
a spring member mounted at the first and second hinge shafts, and applying elastic force to the moving cam.

14. The hinge device of claim 13, wherein the gear unit comprises:
first and second drive gears coupled respectively to the first and second hinge shafts;
a first driven gear rotatably mounted at the hinge case, and engaged with the first drive gear; and
a second driven gear rotatably mounted at the hinge case, and engaged with the first driven gear and the second drive gear.

15. The hinge device of claim 11, wherein the second hinge module comprises:
a fixed member fixedly mounted at least one of the first and second bodies;
a sliding member fixedly mounted at a bottom surface of at least one of the first and second display portions, and slidably coupled to the fixed member; and
an elastic link disposed between and pivotably coupled to the fixed member and the sliding member.

16. The hinge device of claim 15, wherein the elastic link comprises:
an elastic member of a spiral shape pivotably coupled to the fixed member; and
an arm member connected to the elastic member and slidably coupled to the sliding member.
